(19) United States
(12) Patent Application Publication
(10) Pub. No.: US 2013/0000856 A1
(43) Pub. Date: Jan. 3, 2013

(54) METHOD FOR IMPROVING THE PROPERTIES OF A PAPER PRODUCT AND FORMING AN ADDITIVE COMPONENT AND THE CORRESPONDING PAPER PRODUCT AND ADDITIVE COMPONENT AND USE OF THE ADDITIVE COMPONENT

(75) Inventors: Isko Kajanto, Espoo (FI); Annikki Vehniäinen, Helsinki (FI)

(73) Assignee: UPM-KYMMENE OYJ, Helsinki (FI)

(21) Appl. No.: 13/583,980

(22) PCT Filed: Mar. 15, 2011
(86) PCT No.: PCT/FI2011/050218

§ 371 Date: Sep. 11, 2012

(30) Foreign Application Priority Data
Mar. 15, 2010 (FI) 20105254
Dec. 23, 2010 (FI) 20106368

(51) Int. Cl. D21H 11/00; C08B 15/00

(52) U.S. Cl. 162/141; 536/56

(57) ABSTRACT

The invention relates to a method for improving the properties of a paper product and to the corresponding paper product, wherein the paper product is formed from a fiber-based material. According to the invention the fines fraction is separated from chemical cellulose fiber-based pulp substantially after refining, and the cellulose fiber-based pulp from which the fines fraction has been separated is formed into the paper product in a papermaking apparatus. In addition, the invention relates to a method for manufacturing an additive component and to the corresponding additive component.

### FIELD OF THE INVENTION

The invention relates to the method defined in the preamble of claim 1 for improving the properties of a paper product, to the paper product defined in the preamble of claim 8, to the method defined in the preamble of claim 10 for forming an additive component, to the additive component defined in the preamble of claim 17 and to the use of the additive component defined in the preamble of claim 18.

### BACKGROUND OF THE INVENTION

Known from the prior art are different methods for manufacturing paper from different pulps.

In addition, it is known from the prior art to improve the properties of paper by different filling and coating materials, such as pigments, in connection with papermaking. It is known that in papermaking, the aim is to provide the best possible properties for the paper in terms of the application of use. For example, in the manufacture of normal copying paper the aim is to improve water removal ability of the pulp and dimensional stability of the paper. This is nowadays carried out by reducing swelling of the fibers either by drying the chemical pulp before using it in papermaking or by cooking the chemical pulp to a lower kappa number. The drying of chemical pulp increases the total energy need and the cooking of chemical pulp to a lower kappa number reduces the yield.

In addition, the effect of fines on the properties of paper has been much examined. In the studies it has been discovered that sulfate cellulose fines are useful for the strength of paper but negatively affect the scattering of light and the bulk. On the other hand, the fines reduce water removal ability of the pulp, which is harmful for papermaking efficiency. It is also known in current papermaking processes that when the aim is the high strength of paper, the most important objective is to produce well modified fibers and not fines in refining the pulp.

In nanocellulose studies it has been discovered that nanocellulose improves the strength of paper. Nanocellulose has a large specific surface area and thus more bonding area in comparison with material weight. In addition, nanocellulose can be used in a paper coating to replace other binders and to improve stability of the paste. A problem in the use of nanocellulose is its poor concentratability and redispersion after manufacture. Transportation of nanocellulose having a high water content is neither economical nor ecological.

### OBJECTIVE OF THE INVENTION

An objective of the invention is to remedy the preceding problems and to disclose a new type of a method for improving the properties of a paper product and an associated manufacturing method for manufacturing an additive component. Furthermore, an objective of the invention is to disclose a new type of a paper product and additive component.

### SUMMARY OF THE INVENTION

The methods as well as the paper product and additive component according to the invention are characterized by what has been presented in the claims.

The invention is based on a method for improving the properties of a paper product wherein the paper product is formed from a fiber-based material. According to the invention the fines fraction is separated from chemical cellulose fiber-based pulp substantially after refining, and the cellulose fiber based pulp from which the fines fraction has been separated, i.e. the fractionated pulp, is formed into the paper product in a papermaking apparatus.

Furthermore, the invention is based on a paper product. According to the invention the paper product is formed from chemical cellulose fiber-based pulp from which the fines fraction has been separated substantially after refining.

The cellulose fiber-based pulp may be formed from any botanical raw material, e.g. wood based raw material, such as hardwood raw material or softwood raw material.

Chemical cellulose fiber-based pulp and chemical cellulose fiber pulp in this context signify cellulose fiber-based pulp wherein the fibers are separated from each other and most of the lignin has been removed by chemicals using a chemical process that may be e.g. a sulfate process, sulfite process, soda process, a process based on organic solvents or other chemical treatment process known per se in the art.

Removal of the fines from chemical cellulose fiber based-pulp provides advantageous effects for the paper product to be formed and its technical properties. By removal of the fines from the refined cellulose fiber-based pulp it is possible to improve the water removal ability of the pulp and dimensional stability of the paper product while preserving high tensile strength.

The fines fraction to be separated may be of any size, preferably a fines fraction of a predetermined size of the entire fines content in the chemical cellulose fiber-based pulp. The fines fraction may preferably comprise most of the entire fines content or alternatively substantially the entire fines content. The amount of the fines fraction may be 10 to 100% of the entire fines content. A fines fraction in this context signifies any fiber fraction wherein the length of the fibers is preferably less than 0.2 mm.

In one embodiment of the invention the separated fines fraction is formed into an additive component. In one embodiment at least part of the separated fines fraction is formed into an additive component. In one embodiment the separated fines fraction is formed into more than one different additive components. In one embodiment the additive component is formed directly from the fines fraction as such. In one embodiment the additive component is formed from the fines fraction by modifying the fines fraction in a manner suitable for the purpose of use.

In one embodiment of the invention at least part of the separated fines fraction is processed into microfibril cellulose, and the microfibril cellulose is formed into the additive component.

In one embodiment the additive component may be formed from the fines fraction, the processed fines fraction, e.g. microfibril cellulose, or their different combinations. The additive component may also contain different additives suitable for the purpose of use.

In one embodiment of the invention at least one additive component is provided in connection with the paper product that has been formed in order to improve the properties of the paper product. In one embodiment the additive component is used in a paper product coating composition.

In one embodiment of the invention the paper product and additive component are formed and the additive component is used in connection with the paper product to be formed in an integrated pulping and papermaking process.

In addition, the invention is based on a method for forming an additive component in connection with the manufacture of a paper product, wherein the additive component is formed from a fiber-based material. According to the invention the fines fraction is separated from chemical cellulose fiber-based pulp substantially after refining, the separated fines fraction is processed, preferably fibrillated, into microfibril cellulose, and the microfibril cellulose is formed into the additive component. In addition, the invention is based on a corresponding additive component.

By using fines from the pulping process as raw material for microfibril cellulose, it is possible easily to manufacture microfibril cellulose and to provide homogenous microfibril cellulose of good quality.

The invention is specifically based on separating the fines fraction from the chemical cellulose fiber pulp, refining the chemical cellulose fiber pulp to a high refining degree, manufacturing a paper product from fractionated chemical pulp from which the fines fraction has been separated, and/or processing the fines fraction further into an additive. Preferably, the chemical pulp from which the fines fraction has been removed can be used to form a paper product having improved properties. In addition, the additive formed from the fines fraction can, where desirable, be used in the formation of the paper product to improve the properties of the paper product.

Microfibril cellulose in this context signifies cellulose consisting of microfibrils, i.e. a set of isolated cellulose microfibrils or microfibril bundles derived from a cellulose raw material. Cellulose fibers contain microfibrils that are filamentous constituents of cellulose fibers consisting of micellae. A cellulose fiber is made fibrous by fibrillating. The aspect ratio of microfibrils is typically high; the length of microfibrils may be more than one micrometer and the numberaverage diameter is typically less than 200 nm. The diameter of microfibril bundles may be greater but is usually less than 1 μm. The smallest microfibrils are similar to so-called elemental fibrils typically having a diameter of 2 to 12 nm. The dimensions of fibrils or fibril bundles depend on the raw material and disintegration method.

In one embodiment of the invention the microfibril cellulose contains nanocellulose. Nanocellulose consists at least mainly of nano size-class fibrils of a nano size-class diameter which may yet have a μm size-class length or smaller. In one embodiment the microfibril cellulose consists mainly of nanocellulose. In this case, the fines fraction is preferably nanofibrillated into nanocellulose. In one embodiment the fines fraction is processed directly into nanocellulose. In one embodiment the fines fraction is processed into nanocellulose by first forming micro size-class fibrils which are formed into nano size-class fibrils.

In one embodiment of the invention the cellulose fiber-based pulp is subjected to prefractionation before refining. In connection with prefractionation, fines, e.g. a fines fraction, may be separated from the cellulose fiber-based pulp. In prefractionation, fines containing ray cells can be separated from the pulp. This may improve the quality of the products being formed, such as the paper product and the additive component. On the other hand, the separated fines can be utilized in other applications.

In one embodiment the fines separated in prefractionation are formed into the additive component. In one embodiment the fines separated in prefractionation are used as part of another additive component, e.g. as part of an additive component formed from the postrefining fines fraction.

In one embodiment at least part of the fines separated in connection with prefractionation or before refining from the chemical cellulose fiber-based pulp or the additive component formed therefrom is added back to the chemical pulp or to the chemical pulp of another process after prefractionation and/or refining.

In one embodiment the method is provided with a preliminary treatment step before refining, which may be a washing step and/or an additive addition step.

In one embodiment of the invention water is removed from the separated fines fraction.

In one embodiment of the invention a postprocessing step is provided in order to treat the additive component, in one embodiment a postfibrillation step in order to improve the yield of the microfibril cellulose.

In one embodiment of the invention water is removed from the microfibril cellulose in order to raise the concentration of the fibril cellulose.

In one embodiment the fines fraction separated after refining and/or other suitable fines fraction is added to the additive component formed from the microfibril cellulose.

In one embodiment of the invention the additive component is formed substantially in connection with papermaking. In one embodiment the manufacture of microfibril cellulose is carried out in connection with a pulping process line. In one preferred embodiment the manufacture of microfibril cellulose is carried out in connection with an integrated pulping process and papermaking line.

In one embodiment the additive component is used as additive in the manufacture of different products.

In one embodiment of the invention the additive component is used as a paper product additive in papermaking. In one embodiment the additive component can be used as additive in a paper coating or filler composition. The additive component to be formed can be preferably used in improving the properties of a web or paper or as additive in fiber-based products, paperbased products, wood-based products, composite products, plastic-based products and the like and in pulp compositions to be used in their formation. The additive component can be used as a component that increases the strength of paper. The additive according to the invention may be used to improve the strength, such as initial wet strength, of paper. The additive component that has been formed may be used in suspension rheology control and suspension stabilization.

A web in this context signifies any fiber-based web, fibrous web, paper web or an equivalent web. Paper in this context signifies any fiber-based paper, board or fiber product or the like. The web or paper may have been formed from chemical pulp, mechanical pulp, chemimechanical pulp, recycled pulp, fiber pulp and/or botanical pulp. The web or paper may contain suitable fillers and additives and different surface treatment and coating agents.

The method according to the invention can be applied for use in the manufacture of different paper products and, correspondingly, different additives manufactured from the fines fraction of chemical pulp.

In one embodiment the method according to the invention for separating the fines from chemical cellulose fiber-based pulp can be utilized for example at a coating fine paper mill such that the fractionated pulp is used for manufacturing base paper and the additive component formed from the fines is used as a coating additive.

The additive component according to the invention can be utilized in the manufacture of different products e.g. in the paper industry, composite product industry, paint industry, chemicals industry, sheeting industry, food product industry, pharmaceutical industry or an equivalent application. The additive component according to the invention can also be used in the chemicals industry as a thickener. In one embodiment the additive component that has been formed can be used as raw material in an additive or other material component, material composition or material.

The invention provides important advantages as compared with the prior art.

Thanks to the invention, it is possible to manufacture a paper product having improved properties.

In addition, thanks to the invention, the fraction separated from the pulp which is unwanted in papermaking can be utilized in an excellent manner. By the microfibril cellulose formed from the separated fraction it is possible to improve the properties of different products, such as the strength properties of paper.

The methods according to the invention for manufacturing a paper product and an additive component are easily industrially applicable.

### LIST OF FIGURES

FIG. 1 presents one simplified process flow chart for carrying out the method according to the invention.

### DETAILED DESCRIPTION OF THE INVENTION

The invention is described in more detail by the following example with reference to the accompanying FIGURE.

### Example 1

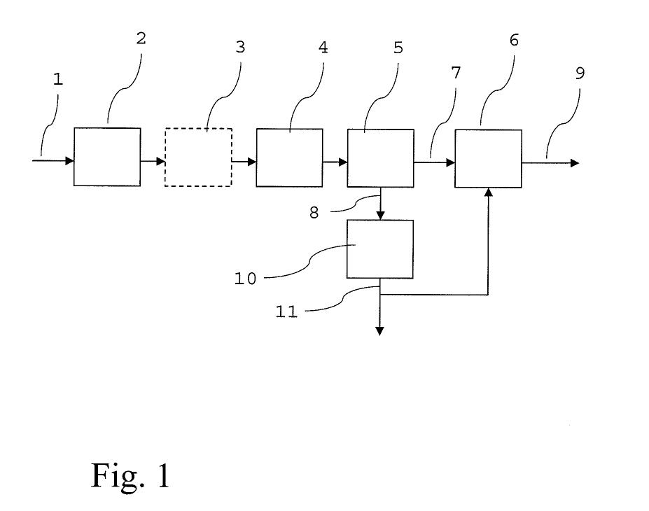

A paper product and additive component were formed according to the process flow chart presented in FIG. 1 in an integrated pulping process and papermaking plant.

The pulping process included a chemical treatment step (2) of a wooden raw material known per se, wherein the chemical treatment was used to form chemical cellulose fiber-based pulp from a hardwood raw material. The chemical cellulose fiber-based pulp was refined at a refining step (4) by at least one refining device known per se, a conical refiner in this connection. In an alternative embodiment the cellulose fiber-based pulp was subjected to prefractionation, e.g. by a device known per se and based on screening technology, at a prefractionation step (3) before refining (4). At a separation, i.e. fractionation, step (5) the fines fraction having a size of less than 0.2 mm was separated from the cellulose fiber-based pulp by a device known per se and based on screening technology. At the fractionation step (5) the fines were separated from the other cellulose fibers.

The cellulose fiber-based pulp (7) from which the fines fraction had been separated was led to a papermaking process step (6), where the pulp was formed into a paper product (9). The fines fraction (8) was led to a fibrillation step (10) in order to nanofibrillate the fines fraction into nanocellulose (11). Water could be removed from the fines fraction before the fibrillation step (10). The employed production device of the microfibril cellulose was the Microfluidics M-710 model. Alternatively it is possible to use any device known per se and applicable for fibrillation. The nanocellulose (11) could be post-processed for example by postfibrillation in order to improve the yield and/or by removing water in order to form gel-type nanocellulose. By the final water removal step, it was possible to reduce moisture and thus for example transportation costs of the nanofibril cellulose (11). The nanocellulose (11) formed could be utilized at the papermaking step (6), for example in coating the paper product, as an additive component of the coating composition, or in another suitable application as an additive component.

At the papermaking step (6), fine paper was formed as the paper product (9). The strength and dimensional stability of the fine paper formed from the fractionated pulp (7) were good. The nanocellulose was used in a composition having a thickness of 2% as a coating additive of the paper product in a paper machine integrated with the process. The additive gave the paper product additional strength and reduced average weight of the paper product. The nanocellulose could also be utilized as an additive component in other applications, for example as a product having a thickness of 10%.

It was discovered that it was possible to form in a simple and at the same time controlled manner paper and an additive component of good quality from the same chemical pulp by separating from the pulp to be used for papermaking the inferior fraction in terms of paper and by using the separated fraction for the manufacture of the additive component. It was discovered that the water removal ability of the chemical pulp from which the fines fraction had been separated was good. In addition, from an economical point of view it was discovered that the production of the paper product and nanocellulose is profitable by the process according to FIG. 1.

The methods according to the invention are applicable as different embodiments to be used for manufacturing most different cellulose-based paper products and/or additive components.

The invention is not limited merely to the example referred to above; instead, many variations are possible within the scope of the inventive idea defined by the claims.

1. A method for improving the properties of a paper product, wherein the paper product is formed from a fiber-based material, characterized in that the fines fraction is separated from chemical cellulose fiber-based pulp substantially after refining, and the cellulose fiber-based pulp from which the fines fraction has been separated is formed into the paper product in a papermaking apparatus.

2. The method according to claim 1, characterized in that the cellulose fiber-based pulp is subjected to prefractionation before refining.

3. The method according to claim 1 or 2, characterized in that the fines fraction is formed into an additive component.

4. The method according to claim 3, characterized in that at least part of the separated fines fraction is processed into microfibril cellulose in order to form an additive component.

5. The method according to claim 3 or 4, characterized in that the additive component is provided in connection with a paper product in order to improve the properties of the paper product.

6. The method according to any one of claims 3 to 5, characterized in that the additive component is used in a coating composition of a paper product.

7. The method according to any one of claims 1 to 6, characterized in that the paper product and additive component are formed, and the additive component is used in connection with the paper product to be formed in an integrated pulping and papermaking process.

8. A paper product, characterized in that the paper product is formed from chemical cellulose fiber-based pulp from which the fines fraction has been separated substantially after refining.

9. The paper product according to claim 8, characterized in that an additive component formed from the separated fines fraction is provided in connection with the paper product.

10. A method for forming an additive component in connection with a pulping process, wherein the additive component is formed from a fiber-based material, characterized in that the fines fraction is separated from chemical cellulose fiber-based pulp substantially after refining, the separated fines fraction is processed into microfibril cellulose, and the microfibril cellulose is formed into the additive component.

11. The method according to claim 10, characterized in that the microfibril cellulose contains nanocellulose.

12. The method according to claim 10 or 11, characterized in that the microfibril cellulose consists mainly of nanocellulose.

13. The method according to any one of claims 10 to 12, characterized in that the cellulose fiber-based pulp is subjected to prefractionation before refining.

14. The method according to any one of claims 10 to 13, characterized in that water is removed from the fines fraction.

15. The method according to any one of claims 10 to 14, characterized in that a postprocessing step is provided in order to improve the yield of the microfibril cellulose.

16. The method according to any one of claims 10 to 15, characterized in that water is removed from the microfibril cellulose.

17. An additive component, characterized in that the additive component is formed from a fines fraction separated from chemical cellulose fiber-based pulp, the fines fraction being separated substantially after refining and processed into microfibril cellulose.

18. Use of the additive component according to claim 17, characterized in that the additive component is used as additive of a paper product in papermaking.
